(19) United States
(12) Patent Application Publication
(10) Pub. No.: US 2022/0339962 A1
(43) Pub. Date: Oct. 27, 2022

(54) DECORATIVE CONTAINER WITH A SPEAKER

(71) Applicant: Alpine Corporation, City of Industry, CA (US)

(72) Inventors: Jodie Winters, Woodland Hills, CA (US); Ninette Parisi, Woodstock, NY (US)

(21) Appl. No.: 17/588,073

(22) Filed: Jan. 28, 2022

Related U.S. Application Data
(60) Provisional application No. 63/180,514, filed on Apr. 27, 2021.

(51) Int. Cl. B44F 1/06; F21V 33/00; A63H 3/28; A63H 3/00; H04R 1/02

(52) U.S. Cl. CPC B44F 1/06; F21V 33/0004; A63H 3/28; A63H 3/006; H04R 1/028

(57) ABSTRACT

Provided is a container comprising: a) a body with a completely or partially hallow interior; b) a light source placed inside the body; c) a speaker placed inside the body; and d) a plurality of openings on the body; wherein sound from the speaker and light from the light source exit from the interior of the body through the openings around the body.

### CROSS-REFERENCE

The present application claims the benefit of U.S. Provisional Patent application No. 63/180,514, filed on Apr. 27 2021, which is incorporated herein by reference in its entirety.

### BACKGROUND

People enjoy the aesthetics of decorative arrangements. Decorative containers, however, have limited functionality. There is a need in the art for decorative containers that are easy to use and provide additional functionality.

### SUMMARY SECTION OF THE INVENTION

Provided is a container comprising a body with a partially or completely hollow interior, a speaker and/or a light source placed inside of the container, a plurality of openings for the light source and/or sound to leave the container, and optionally a decorative element attached to the container. The container with said light source, speaker and power management unit is powered by a power cord. The power cord can be connected to a wall outlet. The container can be a barrel. The decorative element can be a sculpture, statute, character, or a doll, such as a snowman. The container can be a platform that is under the decorative element and/or forms the body of the decorative element. The container can have a flat floor for placement of the speaker and/or light source. The openings can be all around the container, with at least 3 openings being 60 degrees apart from each other. The openings can be arranged in a decorative fashion, such as a star or a snowflake, or other shapes that form an arrangement. There can be multiple arrangements. The container can be made of aluminum and/or a polymer. The container can have an access door and/or panel for allowing access to inside of the container.

Provided is a container comprising: a body with a completely or a partially hallow interior; a light source placed inside the body; a speaker placed inside the body; and a plurality of openings on the body; wherein sound from the speaker and light from the light source exit the interior of the body through the openings that are around the body. The container can further comprise a decorative element attached to the body. The container and the decorative element can together form a sculpture, statute, character, or a doll. The character can be a snowman. The body can be under the decorative element, which can be 0.5 foot to 3 feet above the body. The body can be 1 foot to 4 feet tall. The body can be in form of a barrel. The body can be made from aluminum or a polymer. The interior of the body can have a flat bottom surface. The speaker or the light source can be placed on the flat bottom surface of the body. The container can have a panel for allowing access to inside of the body. The openings can be arranged as a star. The openings can be arranged as a snowflake. The body can be circular. Tt least two of the openings can be at least 60 degrees apart from each other. At least two of the openings can be 60 degrees to 180 degrees apart from each other.

Provided is a container comprising: a body with a completely or a partially hallow interior; a light source placed inside the body; a speaker placed inside the body; a plurality of openings around the body; and a decorative element attached to the body; wherein sound from the speaker and light from the light source exit the interior of the body through the openings that are around the body; wherein the power cord is connected to a wall outlet. The body can be in form of a barrel. The container and the decorative element together can form a sculpture, statute, character, or a doll. The body can be circular and at least two of the openings are at least 60 degrees apart from each other. The decorative element can be head of a snowman.

### BRIEF DESCRIPTION OF THE DRAWINGS

FIG. 1 illustrates a front side view of a snowman barrel.

FIG. 2 illustrates a front view of a snowman barrel.

FIG. 3 illustrates a rear view of a snowman barrel.

FIG. 4 illustrates a left rear view of a snowman barrel.

FIG. 5 illustrates a right rear view of a snowman barrel.

FIG. 6 illustrates a top view of a snowman barrel.

FIG. 7 illustrates a bottom view of a snowman barrel.

FIG. 8 illustrates the internal electronic components and communication.

FIG. 9 illustrates wiring arrangement of the snowman barrel.

FIG. 10 illustrates alternative network arrangements.

FIG. 11 illustrates a flow chart with steps for establishing wireless communication.

FIG. 12 illustrates a light inside of the barrel.

FIG. 13 illustrates a light inside of the barrel.

### DETAILED DESCRIPTION OF THE INVENTION

Provided is a decorative container with a speaker 1 and/or a light source 2 inside thereof.

In one embodiment, the decorative container has a partially or full hollow interior for placement of a speaker 1. The container can have openings 3 on the body 4 for passage of sound and/or light from inside of the hollow interior of the container to the outside of the container.

In one embodiment, the decorative container is a barrel. The decorative container can have a partially or completely hollow interior for placement of a speaker 1.

The interior can have a bottom surface where a speaker 1 and/or a light source 2 is placed on the surface. The bottom of the interior can be flat, where a speaker 1 and/or a light source 2 is attached to the top of the bottom.

The speaker 1 and/or the light source 2 can be powered by a power cord. A solar panel can also be used in conjunction with a rechargeable battery.

The body 4 of the container can have a plurality of openings 3. In one embodiment, the body 4 has between 10 to 500 openings 3. In one embodiment, the body 4 has between 20 and 300 openings 3. In one embodiment, the body 4 has about 50 to 300 openings 3. The openings 3 can be of different sizes and shapes. The area of one or more openings 3, or each opening can be from 0.5 cm square to 5 cm square. In one embodiment, all the openings 3 are circular, with each circle having a diameter of about 0.5 cm to about 2 cm.

The openings 3 can be all around the body 4. If the body 4 is circular, the openings 3 can be arranged all around the circular body. In one embodiment, the body 4 has an opening 3 for passage of sound and/or light source in at least four directions, with each direction between 60 degrees to 90 degrees from at least one other opening. In another embodiment, at least two openings are 180 degrees from each other.

In one embodiment, there are at least three or four openings 3 that are placed in perpendicular fashion to each other. The openings 3 can be arranged in a decorative fashion, such as a star or a snowflake, or other shapes that form an arrangement. There can be multiple arrangements.

The container can have a flat bottom for placement of the speaker 1 and/or the light source 2. In the embodiment where the container has a flat bottom, the speaker 1 and/or the light source 2 are placed on the flat bottom. The speaker 1 and light source 2 can be incorporated as a single unit and attached to the bottom of the container.

In one embodiment, there is a distance of more than 6 inches, such as one foot to three feet between placement of the speaker 1. The sound and/or light source 2 from the container can exit through the plurality of openings 3 on the body 4. The sound and/or light source 2 can exit from different openings 3, even openings that are placed more than 60 degrees to each other, and/or openings that are perpendicular to each other.

The light source 2 placed inside of the container can be LED (light emitting diodes) and can provide white and/or color changing and/or strobing light. The strobing light and/or colors can be synchronized with the sound played on the speaker 1.

The speaker 1 and the light source 2 can be controlled in a wireless fashion, such as with Bluetooth 5.

The container can further have a door/panel 6 where the speaker 1 and the light source 2 can be accessed.

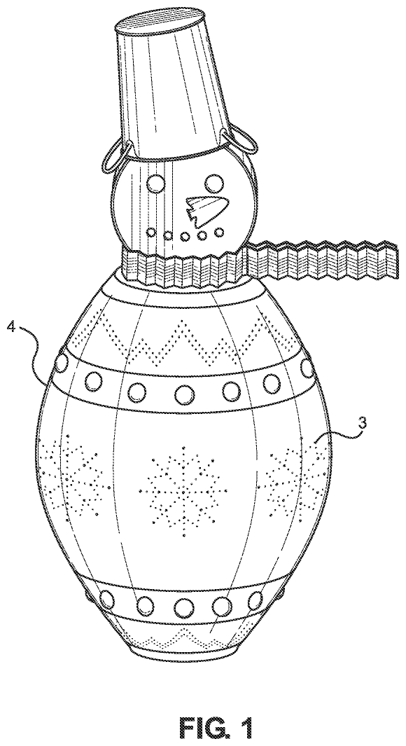

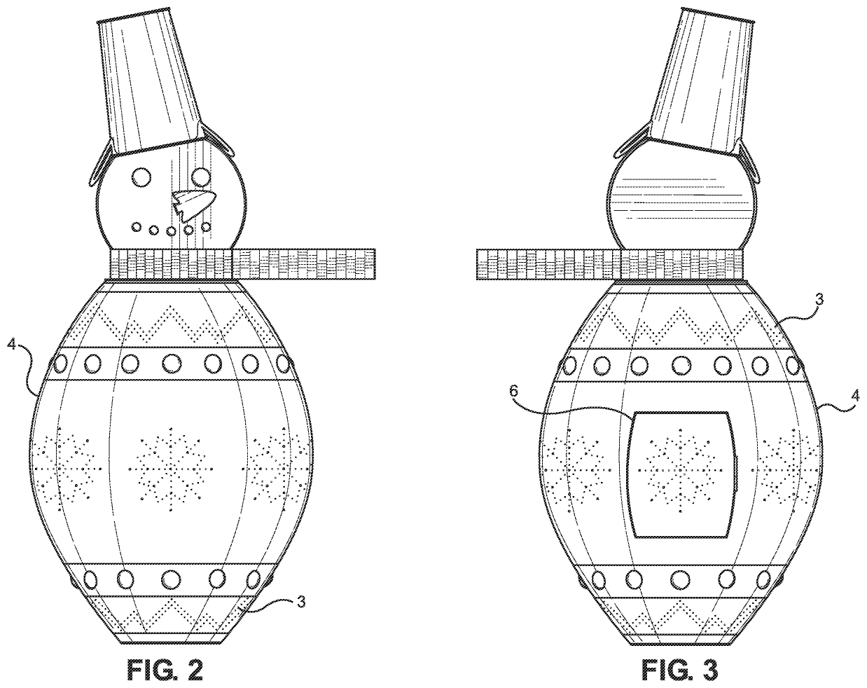

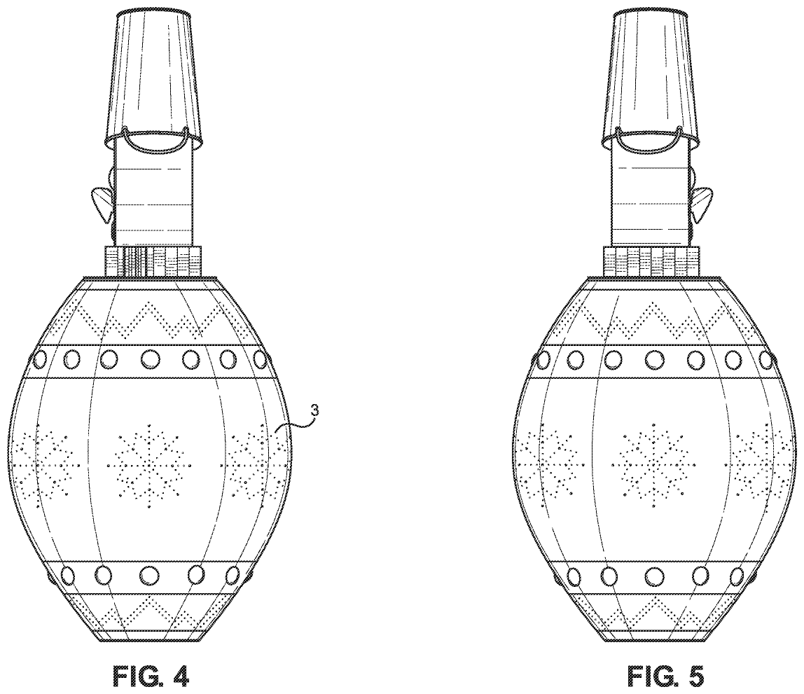

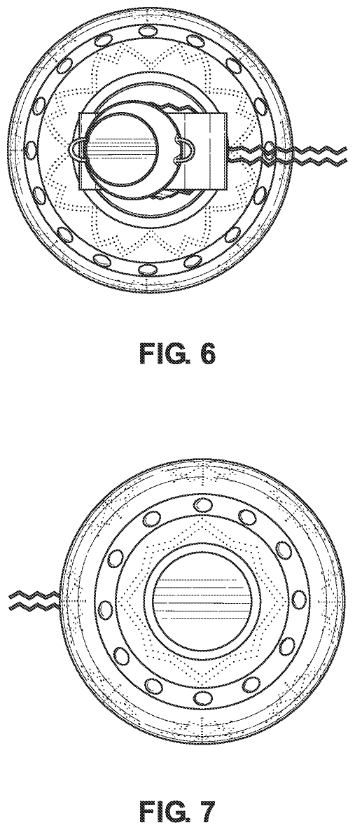

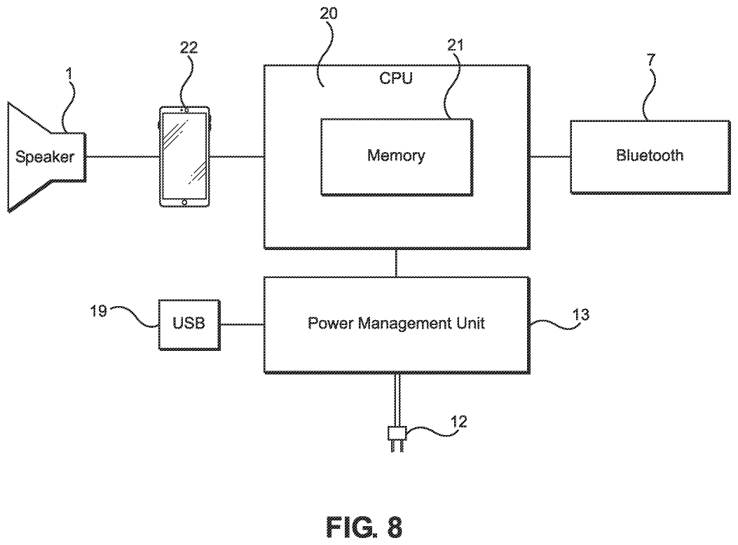

The container can further have decorative elements. In one embodiment, the container is a hollow barrel, and a snowman head is attached to the top of the container. As illustrated in FIG. 1, the barrel makes the body of the snowman, and a snowman head is attached on top of the barrel. A bucket is placed in this embodiment on the top of the head of the snowman. A scarf is attached above the barrel yo the neck of the head, which goes out in a horizontal fashion.

In one embodiment, the container can be sculpture, statute, character, or a doll with a partially or completely hollow interior, and can represent a person, a man, a woman, a child, an animal, a snowman, a gnome, Santa Clause, Eastern Bunny, cupid, Rudolph, elf, deer, polar bear, angel, soldier, penguin, Victorian Caroling Family figure, reindeer, ghost, pumpkin, Jack-O-Lantern, Barrell, Snowman, Christmas tree, Grinch, a dog, presents, Christmas trees. In another embodiment, a sculpture, statute, character, or a doll are attached to a container, and/or the container forms the body of such decorative elements, with the head and/or torso placed above the container.

In another embodiment, the container can be a Snowman, with a partially hollow interior for placement of a speaker 1 and a light source 2. The container can have 10 openings 3 on the body 4 for passage of sound and/or light from inside the partially hollow interior of the container to the outside of the container. The openings 3 around the container can be arranged as snowflakes all around the circular body. The sound and light source 2 from the container can exit through different snowflake openings 3 on the body 4 even openings that are placed more than 60 degrees to each other. The speaker 1 and the light source 2 can be controlled in a wireless fashion, such as with Bluetooth 5. The light source 2 placed inside of the container can be LED (light emitting diodes) and can provide strobing light that is synchronized with the sound played on the speaker 1.

In another embodiment, the container can be the Grinch, with a hollow interior for placement of a speaker 1 and a light source 2. The container can have 300 openings 3 on the body 4 for passage of sound and/or light from inside the hollow interior of the container to the outside of the container. The openings around the container can be arranged as a star. The sound and light source 2 from the container can exit through different star openings 3 on the body 4 even openings that are placed perpendicular to each other. The speaker 1 and the light source 2 can be controlled in a wireless fashion, such as with Bluetooth 5. The light source 2 placed inside of the container can be LED provide color changing synchronized with the sound played on the speaker 1.

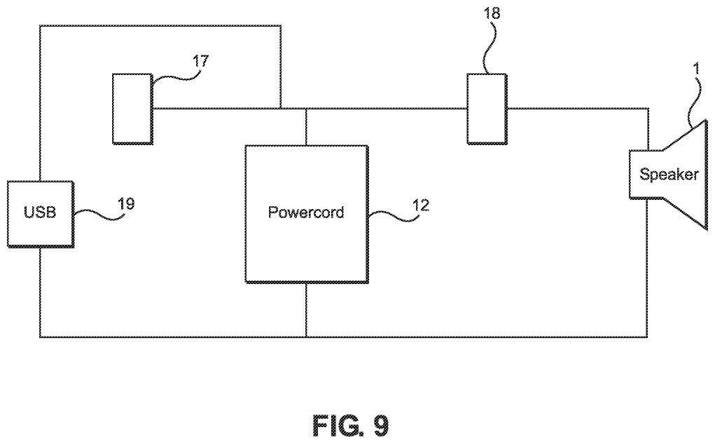

FIG. 9 illustrates the electronic components of the speaker 1, and the source of power that is used to power up the speaker components. The components include a speaker 1, Bluetooth 5, power management unit 13, and power cord 12.

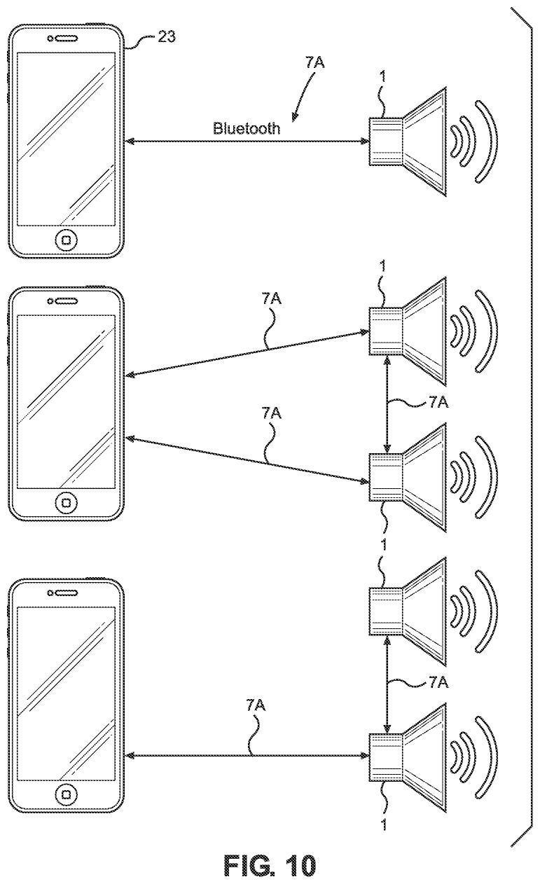

FIG. 10 illustrates possible networking arrangements. The top arrangement illustrates a simple network with electronic device of a user (smart phone 23) and one speaker. The middle illustration shows a mesh network where each speaker can be configured to communicate with the smart phone 23 and every other speaker. The user's phone is also configured to communicate with each speaker. The bottom illustration shows one speaker acting as a master, and then communicating with all the other speakers, in this body 4 sending audio content to the other speakers.

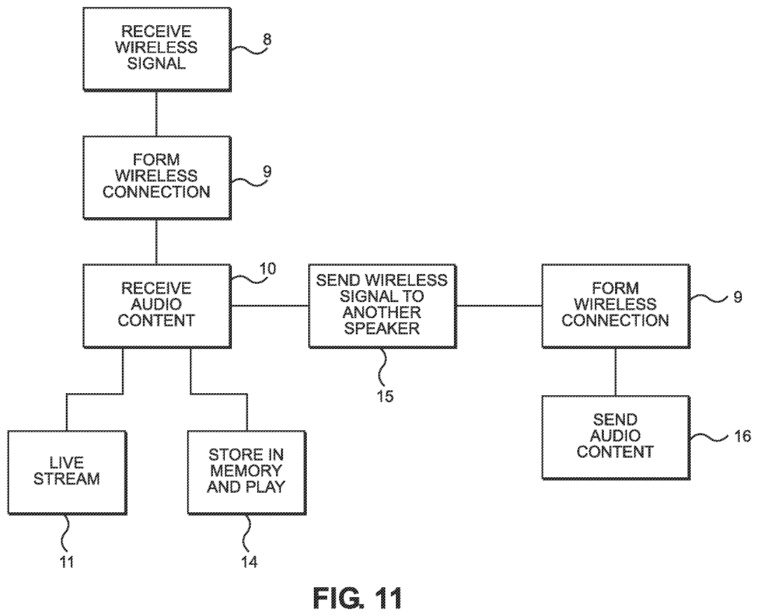

FIG. 11 illustrates wireless electronic communication a user can make to connect with a wireless connection 9, such as by Bluetooth 5, to pair the speaker with a user's electronic device, such as a cellular phone, a tablet computer, or a dedicated music player. The user can then play the contents (such as songs) over the speaker. After receiving a wireless signal 8, the speaker 1, forms a connection (pairs) 9 with the user's device. The speaker 1, then receives audio content 10 from the user's device. The audio content can be played as livestream 11.

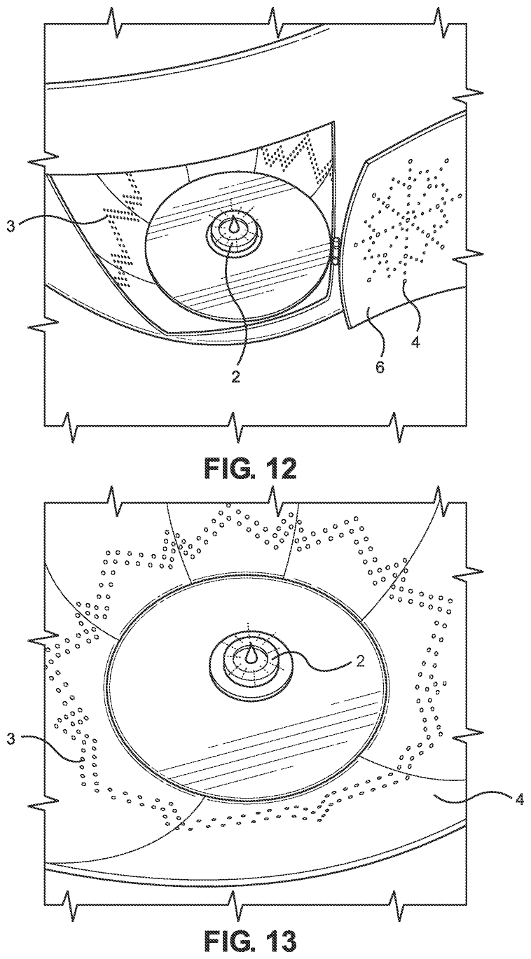

FIG. 12 and FIG. 13 illustrate inside of the barrel with the panel 6 in an open position. As illustrated, placed in the bottom center of the barrel in a concentric fashion is light source 2, which can be an LED light source. Speaker 1 can also be placed next to the light source and/or in another location inside of the barrel.

### REFERENCES

1. Speaker

2. Light Source

3. Openings

4. Body

5. Bluetooth

5A. Bluetooth Communication

6. Panel

7. Receive wireless signal

8. Form wireless connection

9. Receive audio content

10. Livestream

11. Power cord

12. Power management unit

13. Store in Memory and Play

14. Send Wireless Signal to Another Speaker

15. Send Audio Content

16. Internal Switch

17. External Switch

18. USB

19. CPU

20. Memory

21. Speaker Driver

22. Smart Phone

What is claimed:

1. A container comprising:
a) a body with a completely or a partially hallow interior;
b) a light source placed inside the body;
c) a speaker placed inside the body; and
d) a plurality of openings on the body;
wherein sound from the speaker and light from the light source exit the interior of the body through the openings that are around the body.

2. The container of claim 2, further comprising a decorative element attached to the body.

3. The container of claim 2, wherein the container and the decorative element together form a sculpture, statute, character, or a doll.

4. The container of claim 3, wherein the character is a snowman.

5. The container of claim 2, wherein the body is under the decorative element.

6. The container of claim 1, wherein the body is in form of a barrel.

7. The container of claim 1, wherein the body is made from aluminum or a polymer.

8. The container of claim 1, wherein the interior of the body has a flat bottom surface.

9. The container of claim 7, wherein the speaker or the light source is placed on the flat bottom surface of the body.

10. The container of claim 1, further comprising a panel for allowing access to inside of the body.

11. The container of claim 1, wherein the openings are arranged as a star.

12. The container of claim 1, wherein the openings are arranged as a snowflake.

13. The container of claim 1, wherein the body is circular.

14. The container of claim 13, wherein at least two of the openings are at least 60 degrees apart from each other.

15. The container of claim 13, wherein at least two of the openings are at 60 degrees to 180 degrees apart from each other.

16. A container comprising:
a) a body with a completely or a partially hallow interior;
b) a light source placed inside the body;
c) a speaker placed inside the body;
d) a plurality of openings around the body; and
e) a decorative element attached to the body;
wherein sound from the speaker and light from the light source exit the interior of the body through the openings that are around the body;
wherein the power cord is connected to a wall outlet.

17. The container of claim 16, wherein the body is in form of a barrel.

18. The container of claim 16, wherein the container and the decorative element together form a sculpture, statute, character, or a doll.

19. The container of claim 13, wherein the body is circular and at least two of the openings are at least 60 degrees apart from each other.

20. The container of claim 13, wherein the decorative element is head of a snowman.
